(19) United States
(12) Patent Application Publication
(10) Pub. No.: US 2026/0150157 A1
(43) Pub. Date: May 28, 2026

(54) PLANAR-TYPE HEATING APPARATUS AND ELECTRIC OVEN INCLUDING THE SAME

(71) Applicant: SAMSUNG ELECTRONICS CO., LTD., Suwon-si (KR)

(72) Inventors: Moojin KWAK, Suwon-si (KR); Seokhyeon KANG, Suwon-si (KR); Kyoungmok KIM, Suwon-si (KR); Junhan BAE, Suwon-si (KR); Inseon OH, Suwon-si (KR); Sooyoung YU, Suwon-si (KR); Minkyung LEE, Suwon-si (KR); Juhyen LEE, Suwon-si (KR); Yongjoon JANG, Suwon-si (KR); Sungmin CHO, Suwon-si (KR); Donggi HAN, Suwon-si (KR)

(73) Assignee: SAMSUNG ELECTRONICS CO., LTD., Suwon-si (KR)

(21) Appl. No.: 19/451,701

(22) Filed: Jan. 16, 2026

Related U.S. Application Data
(63) Continuation of application No. PCT/KR2025/014215, filed on Sep. 12, 2025.

(30) Foreign Application Priority Data
Nov. 22, 2024 (KR) 10-2024-0168921
Dec. 5, 2024 (KR) 10-2024-0179672

(51) Int. Cl. H05B 3/14; F24C 7/06

(52) U.S. Cl. CPC H05B 3/145; F24C 7/067

(57) ABSTRACT

A planar-type heating apparatus may include: a graphene layer; a graphene oxide film layer on the graphene layer in a first direction; an inorganic oxide film layer on the graphene oxide film layer in the first direction; a first electrode electrically connected to the graphene layer; and a second electrode electrically connected to the graphene layer, wherein the graphene layer is between the first electrode and the second electrode.

### CROSS-REFERENCE TO RELATED APPLICATIONS

This application is bypass continuation of International Patent Application No. PCT/KR 2025/014215, filed on Sep. 12, 2025, which claims priority to Korean Patent Application No. 10-2024-0168921, filed in the Korean Intellectual Property Office on Nov. 22, 2024, and Korean Patent Application No. 10-2024-0179672, filed in the Korean Intellectual Property Office on Dec. 5, 2024, the disclosures of which are hereby incorporated by reference in their entireties.

### BACKGROUND

### 1. Field

The disclosure relates to a planar-type heating apparatus and an electric oven including the same, and more particularly, to an electric oven capable of increasing the temperature inside a cavity relatively consistently by including a planar-type heating apparatus.

### 2. Description of Related Art

In planar-type heating apparatuses in the related art, as heat is emitted when electricity is applied, the apparatuses may stay clean and the temperature may be easily adjustable. In addition, as noise is hardly caused, such planar-type heating apparatuses may be used in heaters for residence, such as apartments, general houses, etc. and heating devices for cooking. Electric ovens, which is a type of the heating devices for cooking, may use an electric heater as a power source, and in this case, a planar-type heating apparatus may be used as the electric heater.

The planar-type heating apparatus may be arranged on one side of an inside of a cavity provided in an electric oven and may apply heat to the cavity to heat up food through natural convection or forced convection. When a plurality of planar-type heating apparatuses are provided as an electric heater in an electric oven, the planar-type heating apparatuses may be exposed to a high-temperature and humid environment during a cooking process.

### SUMMARY

According to an embodiment of the disclosure, a planar-type heating apparatus may include a graphene layer and a graphene oxide film layer arranged to surround the graphene layer.

According to an embodiment of the disclosure, the planar-type heating apparatus may further include an inorganic oxide film layer arranged on the graphene oxide film layer.

According to an embodiment of the disclosure, the planar-type heating apparatus may further include a first electrode electrically connected to the graphene layer and a second electrode electrically connected to the graphene layer and arranged apart from the first electrode with the graphene layer interposed therebetween.

According to an embodiment of the disclosure, an electric oven may include a cavity including a top plate and a bottom plate that face each other, two side plates, and a rear plate, wherein a front of the cavity is open.

According to an embodiment of the disclosure, the electric oven may further include a door configured to selectively open and close the front of the cavity.

According to an embodiment of the disclosure, the electric oven may further include a planar-type heating apparatus on a surface of at least one from among the top plate, the bottom plate, the two side plates, and the rear plate to apply heat to the cavity.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram illustrating an electric oven according to an embodiment of the disclosure;

FIG. 2 is a diagram schematically illustrating a front cross-section of an electric oven according to an embodiment of the disclosure;

FIG. 3 is a diagram schematically illustrating an upper surface of an electric oven according to an embodiment of the disclosure;

FIG. 4 is a perspective view of a planar-type apparatus arranged on a surface of a body defining a cavity according to an embodiment of the disclosure;

FIG. 5 is a perspective view of a planar-type apparatus arranged on a surface of a body defining a cavity according to an embodiment of the disclosure;

FIG. 6 is a diagram schematically illustrating a top surface of a plate of an electric oven on which a planar-type heating apparatus is arranged according to an embodiment of the disclosure;

FIG. 7 is a diagram schematically illustrating a top surface of a plate of an electric oven on which a planar-type heating apparatus is arranged and through which a cooking process of food is recognizable according to an embodiment of the disclosure;

FIG. 8 is a diagram schematically illustrating a top surface of a plate of an electric oven on which a planar-type heating apparatus is arranged according to an embodiment of the disclosure;

FIG. 9 is a cross-sectional view of a planar-type heating apparatus according to an embodiment of the disclosure;

FIGS. 10A to 10F are diagrams for illustrating a method of forming a planar-type heating apparatus according to an embodiment of the disclosure;

FIG. 11A is a photograph of an inorganic oxide layer according to an embodiment of the disclosure; and

FIG. 11B is a photograph of an inorganic oxide layer according to a comparative example.

### DETAILED DESCRIPTION

Example embodiments described in the disclosure and terms used in the disclosure are not intended to limit the scope of the disclosure, and the disclosure includes all modifications, equivalents, and substitutes of the example embodiments.

In the drawings, similar reference numerals denote similar or relevant components.

An expression used in the singular encompasses the expression of the plural unless it has a clearly different meaning in the context.

Throughout the specification, such expressions as “A or B,” “at least one of A and B,” “at least one of A or B,” “A, B, or C,” “at least one of A, B, and C,” and “at least one of A, B, or C” may each include at least one of listed items or any possible combinations thereof.

Such terms as “first,” “second,” etc., may be used to distinguish one component from another and are not intended to limit other aspects of the components (e.g., importance or order).

When a component (e.g., a first component) is described as being “coupled” or “connected” to another component (e.g., a second component) without an expression such as “functionally” or “communicationally,” this may mean that the component is connected to the other component directly (e.g., in a wired manner), wirelessly, or through a third component.

Further, the terms such as “include,” “comprise,” or “have” in the disclosure are used to specify the existence of features, numbers, processes, operations, components, parts recited in the detailed description, or combinations thereof, and thus should not be understood as pre-excluding the existence or possibility for addition of one or more other features, numbers, processes, operations, components, parts, or combinations thereof.

When a component is described as being “connected to,” “combined with,” “supported by,” or “in contact with” another component, this includes not only the cases where the component is directly connected to, combined with, supported by, or in contact with the other component but also the cases where the component is indirectly connected to, combined with, supported by, or in contact with the other component through a third component.

When a component is described as being “on” another component, this includes not only the case where the component is in contact with the other component but also the case where a third component is present between the two components.

The term “and/or” may include combinations of multiple relevant components or any component of multiple relevant components.

Hereinafter, non-limiting example embodiments of the disclosure are described by referring to the attached drawings.

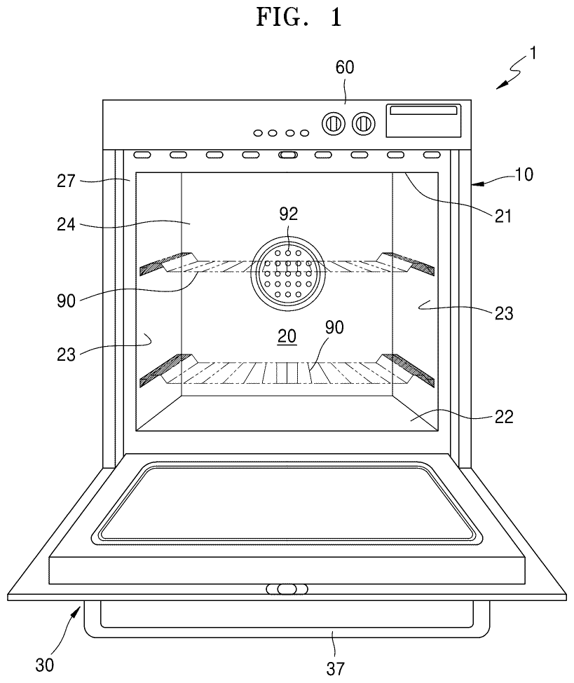

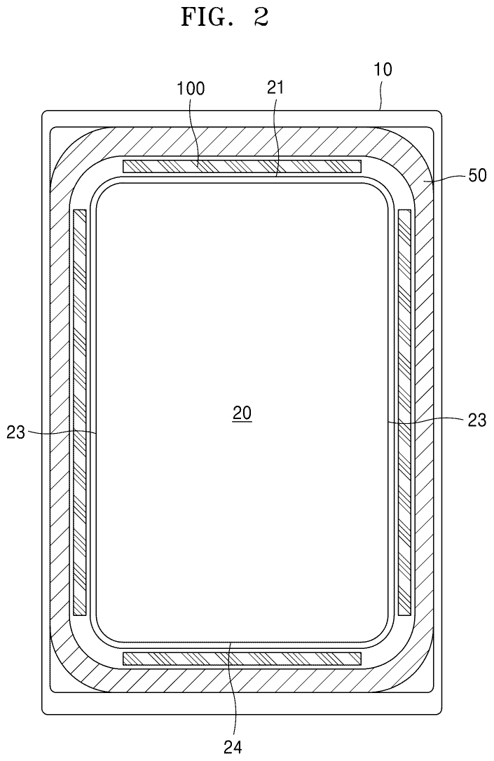

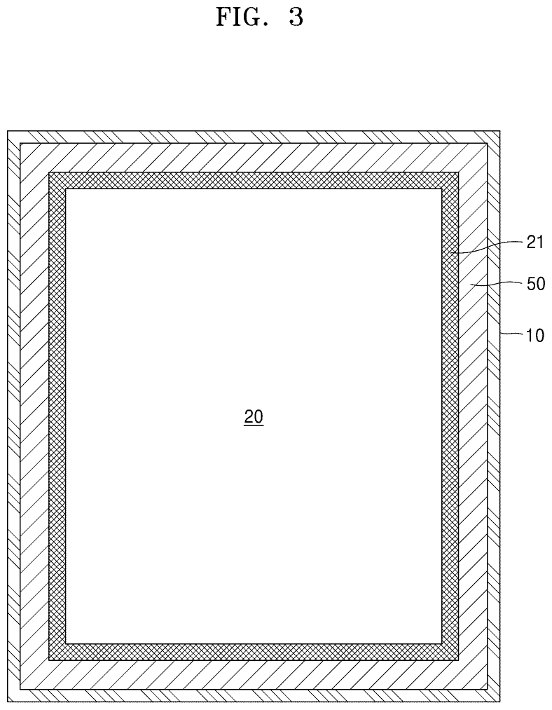

FIG. 1 is a diagram illustrating an electric oven according to an embodiment of the disclosure. FIG. 2 is a diagram schematically illustrating a front cross-section of an electric oven according to an embodiment of the disclosure. FIG. 3 is a diagram schematically illustrating an upper surface of an electric oven according to an embodiment of the disclosure.

Referring to FIGS. 1 to 3, an electric oven 1 according to an embodiment of the disclosure may include a case 10 and a cavity 20 provided in the case 10, such that the case 10 has a front opening that exposes the cavity 20. The exterior of the electric oven 1 may be formed to include a door 30 rotatably coupled to one side of the case 10 to open and close the front opening of the cavity 20.

The case 10 may be arranged at a predetermined distance from the cavity 20. According to an embodiment of the disclosure, the case 10 may include a transparent substrate. According to an embodiment of the disclosure, when the case 10 includes a transparent substrate, visibility may be improved, food that is being cooked inside the cavity 20 may become recognizable, and aesthetic characteristics of the electric oven 1 may be improved. According to an embodiment of the disclosure, the case 10 may include at least one of tempered glass, ceramics, or quartz. However, the disclosure is not limited thereto, and the case 10 may include any transparent material through which visible light is transmitted such that a user can observe the inside of the cavity 20.

The cavity 20 may be a cooking space formed by a top plate 21, a bottom plate 22, two side plates 23, and a rear plate 24. A front plate 27 forming the front opening may be arranged at the front of the cavity 20. According to an embodiment of the disclosure, the case 10 may be arranged at a predetermined distance from the top plate 21, the bottom plate 22, the two side plates 23, and the rear plate 24. Various parts constituting the electric oven 1 may be embedded in a space between the case 10 and the cavity 20, for example, a space between the case 10 and at least one of the top plate 21, the bottom plate 22, the two side plates 23, or the rear plate 24.

At least one rack 90 on which food is put may be arranged inside the cavity 20. A rail to which the rack 90 is attached in a removable manner may be installed on an inner surface of the two side plates 23. A user may move the rack 90 to take out or put food on the rack 90 by using a rail 91.

The door 30 may be hinge-coupled to a lower portion of the case 10 and may be installed to facilitate opening and closing of the cavity 20 by the user. A handle 37 may be attached to an upper portion of the door 30 such that the user may easily rotate the door 30.

The rear plate 24 may include a vent 92 may be arranged to discharge air inside the cavity 20 to the outside. The vent 92 may penetrate the rear plate 24 such that the air inside the cavity 20 may pass through the rear plate 24 via the vent 92. A filter capable of filtering pollutants in the air discharged from the cavity 20 may be installed at the vent 92.

A planar-type heating apparatus 100 may be a heating member which is arranged between the case 10 and the cavity 20 and applies heat to the cavity 20. In an embodiment of the disclosure, there may be at least one planar-type heating apparatus 100, and the at least one planar-type heating apparatus 100 may be arranged to face any one of the top plate 21, the bottom plate 22, the two side plates 23, and the rear plate 24 that define the cavity 20 and may be heated to 400° C. or higher. For example, five planar-type heating apparatuses 100 may be provided, and the planar-type heating apparatuses 100 may face the top plate 21, the bottom plate 22, the two side plates 23, and the rear plate 24, respectively. As described above, as the planar-type heating apparatuses 100 are arranged to correspond to the top plate 21, the bottom plate 22, and the two side plates 23, the heating rate of inside temperature of the cavity 20 may increase, and the temperature inside the cavity 20 may rise consistently.

To insulate the cavity 20 from the outside, an insulating portion 50 may be arranged between the case 10 and the top plate 21, the bottom plate 22, the two side plates 23, and the rear plate 24. In addition, a control panel 60 for controlling operations of the electric oven 1 may be arranged at an upper portion of the case 10.

The insulating portion 50 may block heat transfer between the case 10 and the planar-type heating apparatus 100 such that heat generated from the planar-type heating apparatus 100 is not transferred to the user. According to an embodiment of the disclosure, when the planar-type heating apparatus 100 is arranged in a space formed between the case 10 and the top plate 21, the bottom plate 22, the two side plates 23, and the rear plate 24, the insulating portion 50 may be arranged between the case 10 and the top plate 21, the bottom plate 22, and the two side plates 23 to insulate the cavity 20 from the outside.

According to an embodiment of the disclosure, the insulating portion 50 may include a transparent material. As described above, by improving the visibility, the food that is being cooked inside the cavity 20 may be recognized, and when the case 10, the planar-type heating apparatus 100, and the substrate defining the cavity 20 have a transparent structure through which visible light is transmitted to reinforce the aesthetic characteristics, the insulating portion 50 arranged in the space between the cavity 20 and the case 10 may also include a transparent material. According to an embodiment of the disclosure, the insulating portion 50 may include at least one of tempered glass, ceramics, or quartz. However, the disclosure is not limited thereto, and the insulating portion 50 may include any transparent material through which visible light is transmitted such that a user can observe the inside of the cavity 20.

Hereinafter, the structure of the planar-type heating apparatus 100 arranged outside the cavity 20 and used as an electric heater is described in detail.

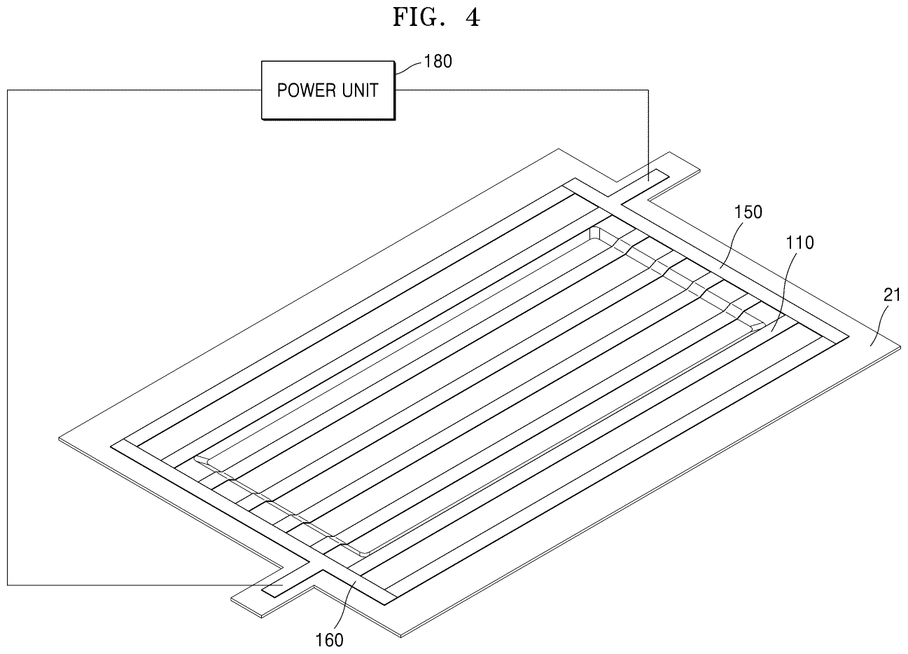

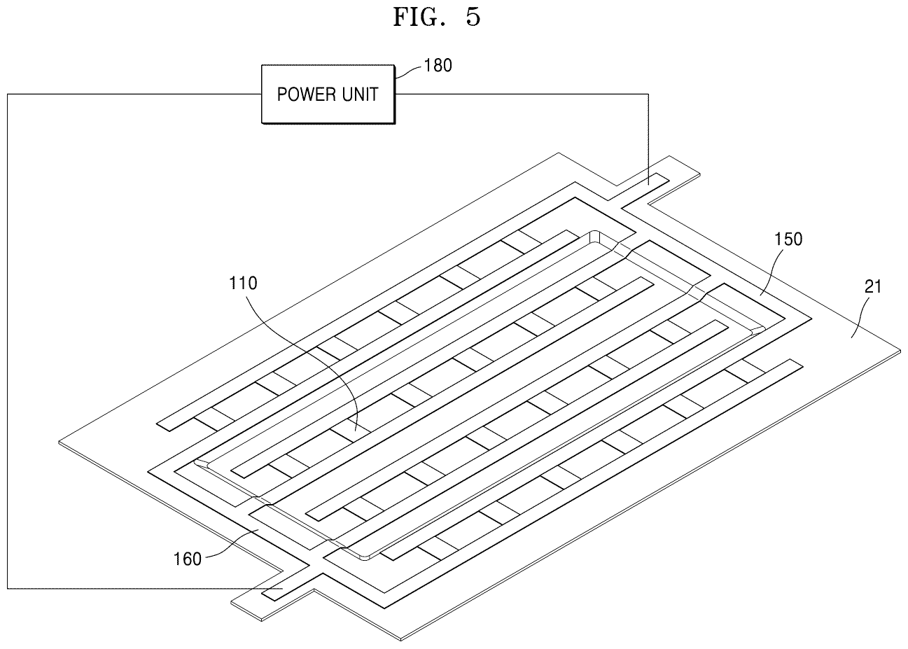

FIG. 4 is a perspective view of a planar-type apparatus arranged on a surface of a body defining a cavity according to an embodiment of the disclosure. FIG. 5 is a perspective view of a planar-type apparatus arranged on a surface of a body defining a cavity according to an embodiment of the disclosure.

Referring to FIGS. 2 and 4, the planar-type heating apparatus 100 according to an embodiment of the disclosure may be a heating member arranged between the case 10 and the cavity 20 to apply heat to the cavity 20. In an embodiment of the disclosure, there may be at least one planar-type heating apparatus 100, and the at least one planar-type heating apparatus 100 may be arranged on at least one of the top plate 21, the bottom plate 22, the two side plates 23, or the rear plate 24 and may heat the cavity 20 to a high temperature. For example, the temperature of the cavity 20 heated by the planar-type heating apparatus 100 may be 400° C. or higher; however, the disclosure is not limited thereto.

In an embodiment of the disclosure, the planar-type heating apparatus 100 may be arranged on a surface of each of the top plate 21, the bottom plate 22, the two side plates 23, and the rear plate 24 included in the cavity 20. As described above, as the planar-type heating apparatus 100 is arranged to correspond to the top plate 21, the bottom plate 22, the two side plates 23, and the rear plate 24, the heating rate of inside temperature of the cavity 20 may increase, and the temperature inside the cavity 20 may rise consistently.

The planar-type heating apparatus 100 according to an embodiment of the disclosure may be formed in a shape of a plate extending along a plane and may include a stacked structure 110 and a first electrode 150 and a second electrode 160 that are arranged with the stacked structure 110 interposed therebetween. In this regard, the first electrode 150 and the second electrode 160 may be arranged to be connected to a power unit 180 (e.g., a power supply).

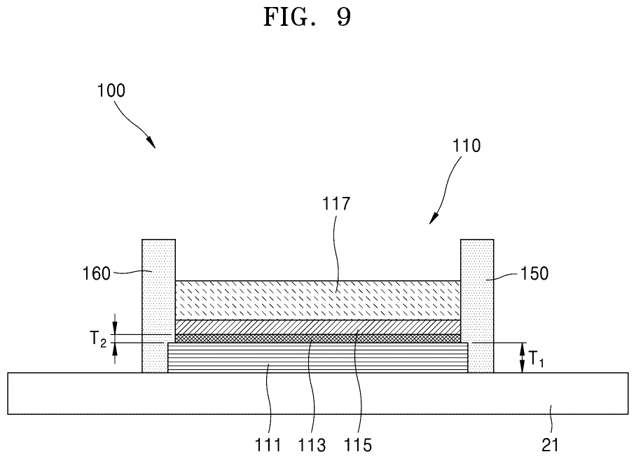

The stacked structure 110 may be arranged on a surface of the body defining the cavity 20 (e.g., on at least one of the top plate 21, the bottom plate 22, the two side plates 23, or the rear plate 24) and may be in contact with the first electrode 150 and the second electrode 160. Accordingly, a graphene layer 111 (see FIG. 9) included in the stacked structure 110 may be electrically connected to the power unit 180.

According to an embodiment of the disclosure, the stacked structure 110 may have a transparent structure through which visible light is transmitted. As described above, by improving the visibility, the food that is being cooked inside the cavity 20 may be recognized, and when the case 10, the planar-type heating apparatus 100, and the substrate defining the cavity 20 have a transparent structure through which visible light is transmitted to reinforce the aesthetic characteristics, the stacked structure 110 arranged in the space between the cavity 20 and the case 10 may also include a transparent structure. According to an embodiment of the disclosure, the stacked structure 110 may include the graphene layer 111 (see FIG. 9) from which heat is generated, a graphene oxide film layer 113 (see FIG. 9) arranged to surround the graphene layer 111, an inorganic oxide film layer 115 (see FIG. 9) arranged on the graphene oxide film layer 113, and a reduced graphene oxide film layer 117 (see FIG. 9) arranged on the inorganic oxide film layer 115. The characteristics of each layer structure included in the stacked structure 110 and the transparent properties of the layer structure are described below in relation to FIGS. 9 to 11B.

The first electrode 150 and the second electrode 160 may be arranged on a surface of a body defining the cavity (e.g., a surface of the top plate 21) and may be in direct contact with the stacked structure 110. In an embodiment of the disclosure, the first electrode 150 and the second electrode 160 may include a material having excellent electric conductivity. For example, the first electrode 150 and the second electrode 160 may include at least one of Ag, Al, indium tin oxide (ITO), Cu, Mo, or Pt.

According to an embodiment of the disclosure, a plurality of stacked structures 110 may be provided, the stacked structures 110 may be arranged apart from each other at predetermined intervals. In an embodiment of the disclosure, as illustrated in FIG. 4, the stacked structure 110 may be arranged on the surface of the body defining the cavity (e.g., a surface of the top plate 21) and extend in a direction. In this regard, the stacked structures 110 may be arranged apart from each other at predetermined intervals.

The first electrode 150 and the second electrode 160 according to an embodiment of the disclosure may be arranged apart from each other with the stacked structure 110 interposed therebetween. For example, the first electrode 150 may be arranged to be in contact with one end of the stacked structure 110, and the second electrode 160 may be arranged to be in contact with the other end of the stacked structure 110. The first electrode 150 and the second electrode 160 respectively arranged at both ends of the stacked structure 110 may include an opaque material through which no visible light passes.

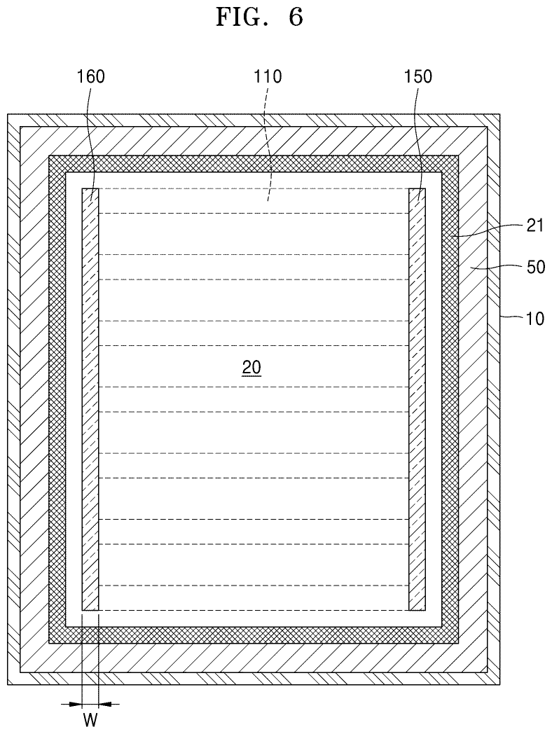

According to an embodiment of the disclosure, when the first electrode 150 and the second electrode 160 include an opaque material through which no visible light passes, the first electrode 150 and the second electrode 160 may have a shape of a thin line having a width W (see FIG. 6) of about 5 nm to about 10 nm. Accordingly, the first electrode 150 and the second electrode 160 may not materially affect a user's view when the user checks the food that is being cooked inside the cavity 20. However, the disclosure is not limited thereto, and the first electrode 150 and the second electrode 160 may include a transparent electrode including a transparent material or have various widths that may not materially affect the user's view.

According to an embodiment of the disclosure, when there are multiple stacked structures 110, the stacked structures 110 may be arranged apart from each other at predetermined intervals. In this regard, the plurality of stacked structures 110 may be arranged apart from each other at predetermined intervals and may be arranged in a lattice forming a plurality of columns as illustrated in FIG. 5, according to an arrangement of the first electrode 150 and the second electrode 160.

In an embodiment of the disclosure, a plurality of first electrodes 150 may be provided as illustrated in FIG. 5, the first electrodes 150 may be arranged apart from each other at predetermined intervals. In addition, there may be one or more second electrodes 160 respectively corresponding to the first electrodes 150, and the second electrodes 160 may be arranged on the surface of the body defining the cavity (e.g., a surface of the top plate 21). For example, when there are multiple second electrodes 160, the second electrodes 160 may be arranged apart from each other at predetermined intervals. In addition, the first electrodes 150 and the second electrodes 160 may be arranged alternately and respectively correspond to each other.

In an embodiment of the disclosure, the first electrode 150 and the second electrode 160 may include a transparent electrode through which visible light is transmitted. Accordingly, the first electrode 150 and the second electrode 160 may not be seen by the user when the user checks the food that is being cooked inside the cavity 20. However, the disclosure is not limited thereto, and when the first electrode 150 and the second electrode 160 includes an opaque material, the first electrode 150 and the second electrode 160 may have a small width and length that may not materially affect a user's view.

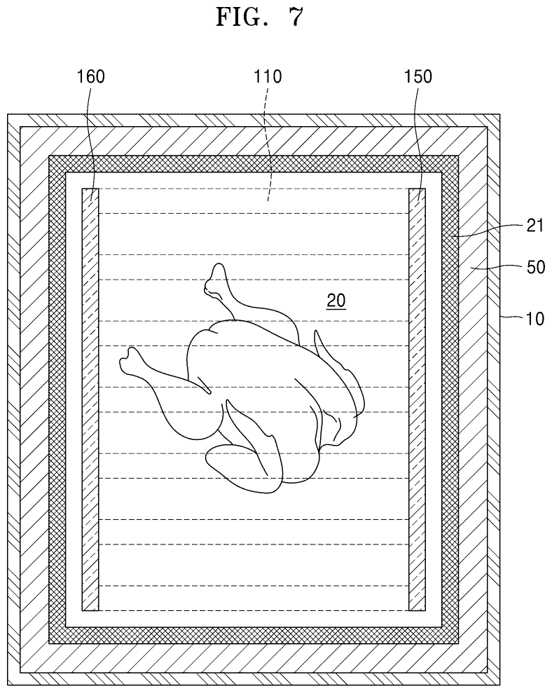

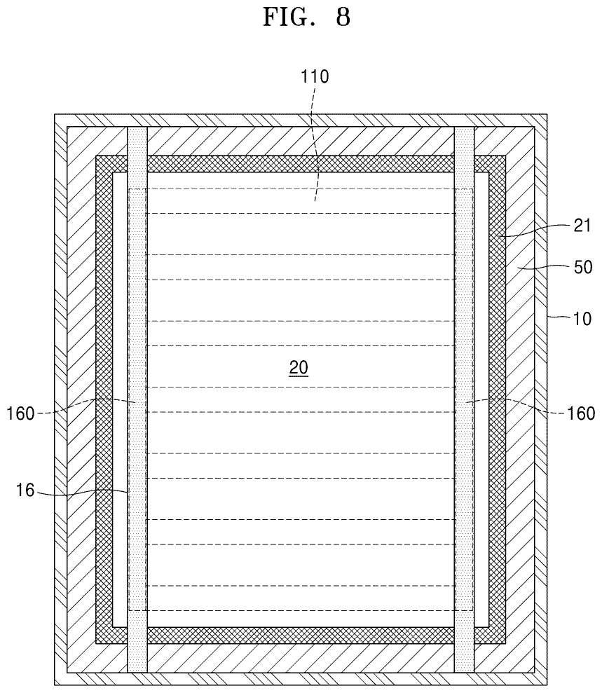

FIG. 6 is a diagram schematically illustrating a top surface of a plate of an electric oven on which a planar-type heating apparatus is arranged according to an embodiment of the disclosure. FIG. 7 is a diagram schematically illustrating a top surface of a plate of an electric oven on which a planar-type heating apparatus is arranged and through which a cooking process of food is recognizable according to an embodiment of the disclosure. FIG. 8 is a diagram schematically illustrating a top surface of a plate of an electric oven on which a planar-type heating apparatus is arranged according to an embodiment of the disclosure.

Referring to FIGS. 6 and 7, a support substrate on which the planar-type heating apparatus 100 according to an embodiment of the disclosure is arranged may have a shape of a plane on which the stacked structure 110, the first electrode 150, and the second electrode 160 may be arranged. In the drawings, the support substrate on which the planar-type heating apparatus 100 is described as a surface of a body defining the cavity 20 (e.g., the top plate 21) for convenient explanation; however, the disclosure is not limited thereto. In an embodiment of the disclosure, the support substrate on which the planar-type heating apparatus 100 is arranged may be a surface of the body defining the cavity 20 (e.g., at least one of the top plate 21, the bottom plate 22, the two side plates 23, or the rear plate 24).

According to an embodiment of the disclosure, a surface of a body defining the cavity 20 on which the planar-type heating apparatus 100 is arranged (e.g., at least one of the top plate 21, the bottom plate 22, the two side plates 23, or the rear plate 24) may include a transparent substrate. According to an embodiment of the disclosure, by improving the visibility, the food that is being cooked inside the cavity 20 may be recognizable, and to improve the aesthetic characteristics, the surface of the body defining the cavity 20 on which the planar-type heating apparatus 100 is arranged may include a transparent substrate.

According to an embodiment of the disclosure, at least one of the top plate 21, the bottom plate 22, the two side plates 23, or the rear plate 24 may include a transparent material having heat resistance. For example, the transparent material included in at least one of the top plate 21, the bottom plate 22, the two side plates 23, or the rear plate 24 may include at least one of tempered glass, ceramics, or quartz glass. However, the disclosure is not limited thereto, and at least one of the top plate 21, the bottom plate 22, the two side plates 23, or the rear plate 24 may include any transparent material having heat resistance to high temperature of 400° C. or higher.

As described above, when a surface of the body defining the cavity 20 includes a transparent substrate, visible light may be transmitted through the case 10, the insulating portion 50, the stacked structure 110 included in the planar-type heating apparatus 100, and the surface of the body defining the cavity (e.g., a surface of the top plate 21). Accordingly, as illustrated in FIG. 7, the food that is being cooked inside the cavity 20 may be recognized, and the visibility of the user during the cooking process may be improved. According to an embodiment of the disclosure, as the first electrode 150 and the second electrode 160 included in the planar-type heating apparatus 100 include a transparent electrode or have a shape of a thin line having a predetermined width W, the user's view may not be materially affected.

As described above, when the first electrode 150 and the second electrode 160 include an opaque material, the width W of the first electrode 150 and the second electrode 160 may be adjusted to avoid materially affecting the user's view In a comparative embodiment, when the width W of the first electrode 150 and the second electrode 160 exceeds a predetermined range for convenience in design, the first electrode 150 and the second electrode 160 may materially affect a user's view.

Referring to FIG. 8, a bezel portion 16 according to an embodiment of the disclosure may be arranged on the case 10 and in an area corresponding to the first electrode 150 and the second electrode 160. In an embodiment of the disclosure, the bezel portion 16 may be a decorative member for hiding the first electrode 150 and the second electrode 160 such that the first electrode 150 and the second electrode 160 are not seen by the user. For example, the bezel portion 16 may be an opaque decorative member having various colors or shapes. As the bezel portion 16 is arranged to hide the first electrode 150 and the second electrode 160, the user may not see the first electrode 150 and the second electrode 160 when the user checks the cooking process, and aesthetics of the electric oven 1 may be improved.

Referring to FIGS. 2 and 6, as described above, at least one of the top plate 21, the bottom plate 22, the two side plates 23, or the rear plate 24 may include a transparent substrate to improve visibility. In this regard, the rest of the plates that do not include a transparent substrate may include an opaque substrate. In an embodiment of the disclosure, when the electric oven 1 has buried structure in which only the top portion and the door 30 are exposed to the outside, only the top plate 21 may include a transparent substrate. In this case, the upper surface of the case 10 corresponding to the top plate 21, the planar-type heating apparatus 100 arranged between the top plate 21 and upper surface of the case 10, and the insulating portion 50 may also transmit the visible light. In addition, except for the top plate 21, the bottom plate 22, the two side plates 23, and the rear plate 24 may include an opaque substrate for convenience in manufacturing. In this regard, the planar-type heating apparatus 100 and the insulating portion 50 (which are arranged between areas of the case 10 that respectively correspond to the bottom plate 22, the two side plates 23, and the rear plate 24), and the bottom plate 22, the two side plates 23, and the rear plate 24 may also have an opaque structure through which no visible light is transmitted.

In an embodiment of the disclosure, when the electric oven 1 has an exposed structure in which the upper portion, the two side portions, the rear portion, and the door 30 are exposed, the top plate 21, the two side plates 23, and the rear plate 24 as well as the upper portion, the both side portions, the rear portion of the case 10 that respectively correspond thereto may include a transparent structure. Furthermore, the planar-type heating apparatus 100 and the insulating portion 50 (which are arranged between the upper portion, the two side portions, and the rear portion of the case 10) and the top plate 21, the two side plates 23, and the rear plate 24 may also include a transparent structure. In this regard, the bottom plate 22, the bottom portion of the case 10, and the planar-type heating apparatus 100 and the insulating portion 50, which are arranged between the bottom plate 22 and the bottom portion of the case 10, may include an opaque structure for convenience in manufacturing.

In an embodiment of the disclosure, even when the electric oven 1 has an exposed structure in which the upper portion, the two side portions, the rear portion, and the door 30 are exposed to the outside, considering the aesthetic impression, at least one of the top plate 21, the two side plates 23, or the rear plate 24 (e.g., the two side plates 23 and the rear plate 24) the areas of the case 10 that correspond thereto, and the planar-type heating apparatus 100 and the insulating portion 50 that are arranged between the case 10 and the two side plates 23 and the rear plate 24 may include an opaque structure.

When at least one of the top plate 21, the bottom plate 22, the two side plates 23, or the rear plate 24 includes an opaque substrate, the opaque substrate may be implemented as a support substrate including a metal material. In this regard, an enamel substrate surrounding the opaque substrate may be arranged with the opaque substrate interposed therebetween. The enamel substrate surrounding the opaque substrate may include a plastic material such as enamel, etc.

Hereinafter, the structure of the planar-type heating apparatus 100 arranged on one surface of the body defining the cavity 20 of an electric oven is described in detail. Although the surface of the body defining the cavity 20 on which the planar-type heating apparatus 100 is arranged is referred to as the top plate 21 for convenient explanation, such description may also be applicable to the bottom plate 22, the two side plates 23, and the rear plate 24.

FIG. 9 is a cross-sectional view of a planar-type heating apparatus according to an embodiment of the disclosure.

Referring to FIG. 9, the planar-type heating apparatus 100 according to an embodiment of the disclosure may include the stacked structure 110 arranged on the surface of the body defining the cavity 20 (e.g., a surface of the top plate 21), and the first electrode 150 and the second electrode 160 that are respectively arranged on opposite sides of the stacked structure 110. In an embodiment of the disclosure, the stacked structure 110 may extend along a plane and may include the graphene layer 111 having a predetermined thickness, the graphene oxide film layer 113 arranged to surround the graphene layer 111, the inorganic oxide film layer 115 arranged on the graphene oxide film layer 113, and the reduced graphene oxide film layer 117 arranged on the inorganic oxide film layer 115.

The graphene layer 111 may be arranged on the surface of the body defining the cavity 20 (e.g., a surface of the top plate 21) and may be in contact with the first electrode 150 and the second electrode 160 between the first electrode 150 and the second electrode 160. Accordingly, the graphene layer 111 may be electrically connected to the first electrode 150 and the second electrode 160. The first electrode 150 and the second electrode 160 may be connected to the power unit 180 (see FIG. 4), and accordingly, the graphene layer 111 may receive a predetermined voltage from the power unit 180 and generate heat.

The graphene layer 111 according to an embodiment of the disclosure may be a single-layer graphene structure or a multi-layer graphene structure in which multiple graphene layers are stacked. In an embodiment of the disclosure, the graphene layer 111 may have a predetermined thickness T₁ (e.g., a thickness of about 1 nm to about 5 nm). Accordingly, the graphene layer 111 may be a transparent material layer through which visible light is transmitted. In addition, the graphene layer 111 may have a resistance which may generate heat of high temperature. However, the disclosure is not limited thereto, and the thickness of the graphene layer 111 may be determined variously according to a heating temperature of the cavity 20 and an arrangement area of the planar-type heating apparatus 100.

The graphene oxide film layer 113 may be arranged between the graphene layer 111 and the inorganic oxide film layer 115 to bond the graphene layer 111 and the inorganic oxide film layer 115. In addition, the graphene oxide film layer 113 according to an embodiment of the disclosure may be arranged to surround the graphene layer 111 and may be a passivation layer protecting the graphene layer 111. The graphene oxide film layer 113 according to an embodiment of the disclosure may be arranged to surround the graphene layer 111 and prevent the graphene layer 111 from being oxidized in a high-temperature and moist oxygen atmosphere.

The graphene oxide film layer 113 according to an embodiment of the disclosure may be formed by performing an oxidation process on the graphene layer 111 having a predetermined thickness to oxidize a partial area of the graphene layer 111. In an embodiment of the disclosure, when the graphene layer 111 having a predetermined thickness is arranged, and an oxidation process for graphene is performed on the graphene layer 111, the graphene oxide film layer 113 may be formed in a thickness direction from an outermost surface of the graphene layer 111.

In an embodiment of the disclosure, after the oxidation process is completed, a ratio between the thickness T₁ of the graphene layer 111 and a thickness T₂ of the graphene oxide film layer 113 may be, for example, 3:1 to 5:1. In this regard, the thickness T₂ of the graphene oxide film layer 113 may be about 0.3 nm to about 1 nm. However, the disclosure is not limited thereto, and the thickness T₂ of the graphene oxide film layer 113 may vary according to the adhesive force between the graphene layer 111 and the inorganic oxide film layer 115 and a degree of required protection of the graphene layer 111.

The inorganic oxide film layer 115 may be arranged on the graphene oxide film layer 113 and may be a passivation layer protecting the graphene layer 111. In an embodiment of the disclosure, the inorganic oxide film layer 115 may be arranged on the graphene layer 111 and prevent the graphene layer 111 from being oxidized in a high-temperature and moist oxygen atmosphere. The inorganic oxide film layer 115 according to an embodiment of the disclosure may include an inorganic oxide that may secure encapsulating characteristics regarding the graphene layer 111 and visible light-transmissive characteristics. For example, the inorganic oxide film layer 115 may include at least one of SiO₂, TiO₂, Si₃N₄, or MoO₃.

The inorganic oxide film layer 115 according to an embodiment of the disclosure may be a transparent material layer to secure visibility such that an outside user may check the cooking process inside the cavity 20. In an embodiment of the disclosure, the inorganic oxide film layer 115 may be a thin film having a predetermined thickness such as, for example, about 10 nm to about 40 nm. Accordingly, the inorganic oxide film layer 115 may be a transparent material layer through which visible light is transmitted. However, the disclosure is not limited thereto, and the inorganic oxide film layer 115 may have any thickness that facilitates the transmission of the visible light.

In a comparative embodiment, a deformation may occur at an interface between a graphene layer and an inorganic oxide film layer due to a difference in coefficient of thermal expansion, and this may cause deadhesion or delamination of the graphene layer and the inorganic oxide film layer. When the graphene layer and the inorganic oxide film layer are detached or delaminated, the graphene layer may be exposed to the high-temperature moist oxygen atmosphere, which may lead to oxidation of the graphene layer. When the graphene layer is oxidized, the heating characteristics may be degraded.

According to an embodiment of the disclosure, the graphene oxide film layer 113 may be arranged between the graphene layer 111 and the inorganic oxide film layer 115 to bond the graphene layer 111 and the inorganic oxide film layer 115. The graphene oxide film layer 113 may have both excellent mechanical characteristics of the graphene layer 111 and oxide properties facilitating the chemical bond with the inorganic oxide film layer 115 through an oxygen functional group. Accordingly, the graphene oxide film layer 113 may bond the graphene layer 111 and the inorganic oxide film layer 115 and prevent deadhesion or delamination of the graphene layer 111 and the inorganic oxide film layer 115. Thus, the graphene layer 111 may be prevented from being exposed to a high-temperature moist oxygen atmosphere, and the oxidation of the graphene layer 111 may be avoided.

The reduced graphene oxide film layer 117 may be arranged on the inorganic oxide film layer 115 and protect the graphene layer 111. The reduced graphene oxide film layer 117 according to an embodiment of the disclosure may have hydrophobicity by performing a reduction process on the graphene oxide film layer. As the reduced graphene oxide film layer 117 has hydrophobicity, the graphene layer 111 may be protected from moisture.

The reduced graphene oxide film layer 117 according to an embodiment of the disclosure may have a predetermined thickness such as, for example, about 1 nm to about 5 nm. However, the disclosure is not limited thereto, and the thickness of the reduced graphene oxide film layer 117 may be adjusted according to a moist atmosphere.

The first electrode 150 and the second electrode 160 may be arranged apart from each other with the graphene layer 111 interposed therebetween. The first electrode 150 and the second electrode 160 according to an embodiment of the disclosure may be electrically connected to the graphene layer 111 to electrically connect the graphene layer 111 to the power unit 180 (see FIG. 4). According to an embodiment of the disclosure, the first electrode 150 and the second electrode 160 may include a material having excellent electric conductivity. For example, the first electrode 150 and the second electrode 160 may include at least one of Ag, Al, ITO, Cu, Mo, or Pt.

The first electrode 150 and the second electrode 160 according to an embodiment of the disclosure may be provided as a transparent electrode to secure visibility such that the outside user may check the cooking process inside the cavity 20. In an embodiment of the disclosure, when the first electrode 150 and the second electrode 160 include ITO, the first electrode 150 and the second electrode 160 may be a transparent material layer through which visible light is transmitted. However, the disclosure is not limited thereto, and the first electrode 150 and the second electrode 160 may include an opaque conductive metal material.

In an embodiment of the disclosure, when the first electrode 150 and the second electrode 160 include Ag, the first electrode 150 and the second electrode 160 may be an opaque material layer through which no visible light is transmitted. In this regard, the first electrode 150 and the second electrode 160 may be implemented as a thin line having a predetermined width W (e.g., a thickness of about 5 nm to about 10 nm). As the first electrode 150 and the second electrode 160 are implemented as a thin line that may not be easily seen by the user, even when the first electrode 150 and the second electrode 160 are arranged, the visibility may be secured, and the outside user may see the cooking process inside the cavity 20.

Hereinafter, a method of forming the planar-type heating apparatus 100 arranged on the surface of the body defining the cavity 20 (e.g., a surface of the top plate 21) is further described in detail.

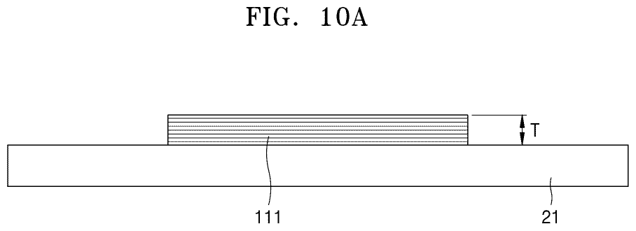

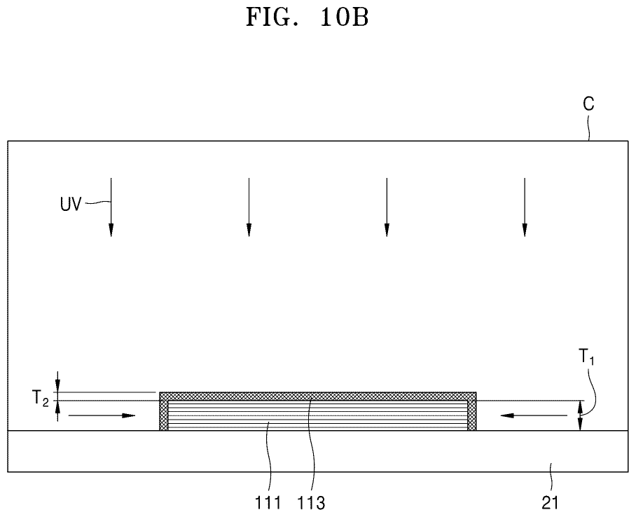

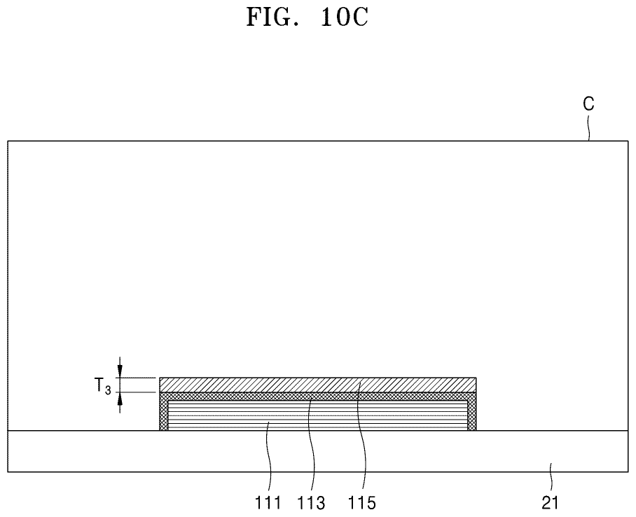

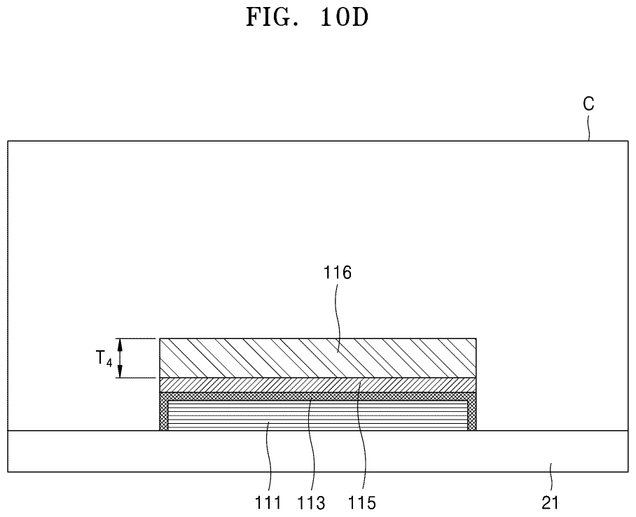

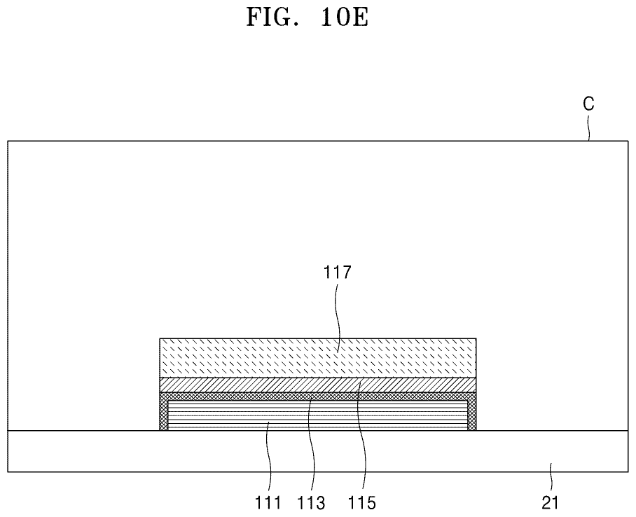

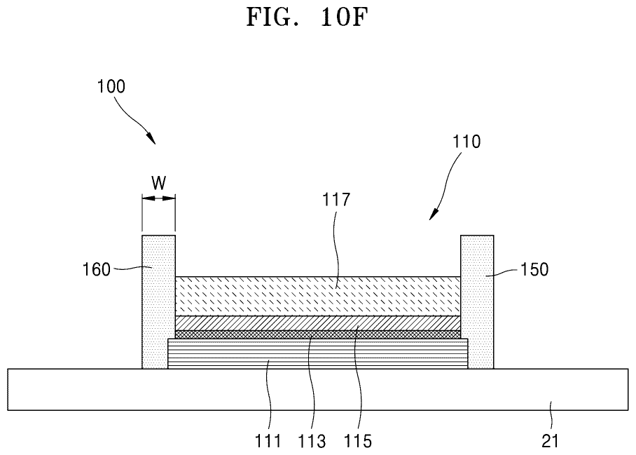

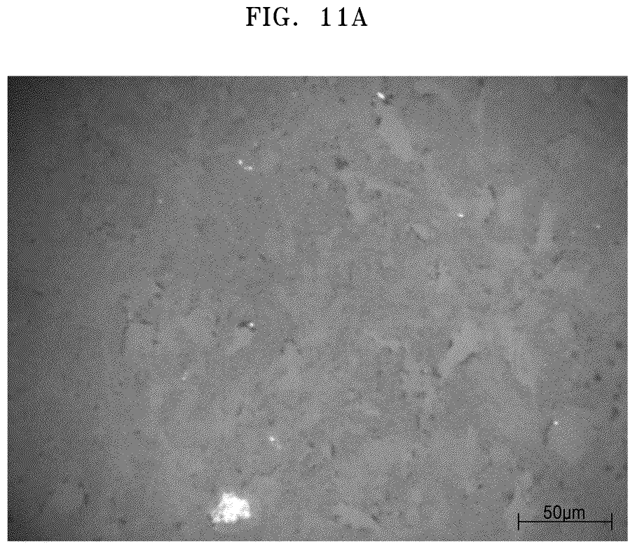

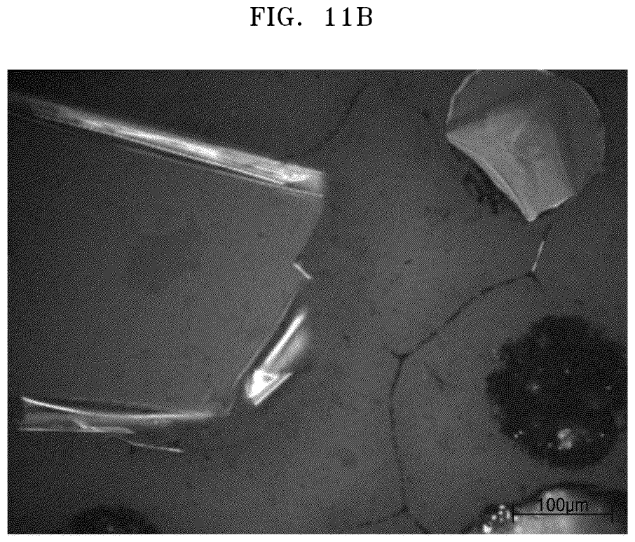

FIGS. 10A to 10F are diagrams for illustrating a method of forming a planar-type heating apparatus according to an embodiment of the disclosure. FIG. 11A is a photograph of an inorganic oxide layer according to an embodiment of the disclosure. FIG. 11B is a photograph of an inorganic oxide layer according to a comparative example.

Referring to FIG. 10A, the graphene layer 111 having a predetermined thickness T may be arranged on the surface of the body defining the cavity 20 (e.g., a surface of the top plate 21). The graphene layer 111 according to an embodiment of the disclosure may be a single-layer graphene structure or a multi-layer graphene structure in which multiple graphene layers are stacked. After the graphene layer 111 is grown to have a predetermined thickness, the graphene layer 111 may be transferred onto the surface of the body defining the cavity 20 (e.g., a surface of the top plate 21). However, the disclosure is not limited thereto, and the graphene layer 111 may be grown directly on the surface of the body defining the cavity 20 (e.g., a surface of the top plate 21). The thickness T of the graphene layer 111 arranged on the surface of the body defining the cavity 20 (e.g., a surface of the top plate 21) may be thicker than the thickness T₁ of the graphene layer 111 arranged in the planar-type heating apparatus 100.

Referring to FIG. 10B, the graphene layer 111 arranged on the surface of the body defining the cavity 20 (e.g., a surface of the top plate 21) may be arranged inside a reaction chamber C, and the oxidation process may be performed on a partial area of the graphene layer 111 to form the graphene oxide film layer 113. When the oxidation process is performed on the graphene layer 111 having a predetermined thickness, the graphene oxide film layer 113 may be formed in the thickness direction from the outermost surface of the graphene layer 111.

More specifically, first, the graphene layer 111 arranged on the surface of the body defining the cavity 20 (e.g., a surface of the top plate 21) may be arranged inside the reaction chamber C. Ultraviolet rays UV having a predetermined wavelength (e.g., a wavelength of 254 nm) may be irradiated on the graphene layer 111 arranged inside the reaction chamber C. The carbon-carbon bond of the graphene included in the graphene layer 111 may be broken by the ultraviolet rays UV, and accordingly, there may be a space for bonds with oxygen.

When the ultraviolet rays UV are irradiated inside the reaction chamber C, ozone (O₃) may be injected into the reaction chamber C to form an oxygen functional group. The ozone (O₃) injected into the reaction chamber C may form various oxygen functional groups by reacting with a graphene surface along with active oxygen species generated by the ultraviolet rays UV. The concentration of the ozone (O₃) inside the reaction chamber C according to an embodiment of the disclosure may be about 50 ppm to about 60 ppm.

The process temperature for oxidizing the graphene included in the graphene layer 111 may be room temperature. In addition, the process pressure for oxidizing the graphene included in the graphene layer 111 may be atmospheric pressure. Furthermore, the process time for oxidizing the graphene included in the graphene layer 111 may be about 40 minutes to about 60 minutes. However, these are only an example, and other process temperatures, process pressures, and process times may be used.

As the oxidation process is performed on the graphene included in the graphene layer 111, the graphene oxide film layer 113 may be formed in the thickness direction from the outermost surface of the graphene layer 111. Accordingly, the thickness T₁ of the graphene layer 111 and the thickness T₂ of the graphene oxide film layer 113 may be inversely proportional to each other. For example, when the oxidation process time increases, the thickness T₂ of the graphene oxide film layer 113 may increase whereas the thickness T₁ of the graphene layer 111 decreases.

In this embodiment of the disclosure, the oxidation method using ultraviolet ozone processing may be provided as an oxidation process performed on the graphene layer 111 having a predetermined thickness; however, the disclosure is not limited thereto. According to an embodiment of the disclosure, various oxidation process such as the Hummers method, thermal oxidation method, etc., may be used to oxidize the graphene layer 111.

Referring to FIG. 10C, the inorganic oxide film layer 115 may be deposited on the graphene oxide film layer 113. The inorganic oxide film layer 115 may include an inorganic oxide that may secure encapsulating characteristics regarding the graphene layer 111 and visible light-transmissive characteristics. For example, the inorganic oxide film layer 115 may include at least one of SiO₂, TiO₂, Si₃N₄, or MoO₃.

In an embodiment of the disclosure, when SiO₂ is deposited as an inorganic oxide included in the inorganic oxide film layer 115 by using atomic layer deposition (ALD), first, a precursor for forming SiO₂ (e.g., at least one of tetraethyl orthosilicate (TEOS), hexamethyldisilazane (HMDS), or silane (SiH₄)) may be injected into the reaction chamber C. The precursor injected into the reaction chamber C may be adsorbed to the graphene oxide film layer 113.

Next, a reaction gas (e.g., at least one of H₂O, O₂, or O₃) may be introduced for reaction with the adsorbed precursor. According to the reaction between the precursor and the reaction gas, SiO₂ may be deposited.

According to an embodiment of the disclosure, by periodically repeating the supply process of precursor and the supply process of reaction gas, the thickness of the inorganic oxide film layer 115 may be adjusted. According to an embodiment of the disclosure, the supply process of precursor and the supply process of reaction gas may be controlled such that the inorganic oxide film layer 115, which secures encapsulating characteristics and visible-light transmissive characteristics, has a predetermined thickness T₃ (e.g., about 10 nm to about 40 nm).

In an embodiment of the disclosure, the ALD is described as the deposition process for forming the inorganic oxide film layer 115; however, the disclosure is not limited thereto, and the inorganic oxide according to an embodiment of the disclosure may be deposited on the graphene oxide film layer 113 through at least one of a thermal oxidation process, chemical vapor deposition (CVD), or a sputtering process.

According to an embodiment of the disclosure, the graphene oxide film layer 113 may be arranged between the graphene layer 111 and the inorganic oxide film layer 115 to bond the graphene layer 111 and the inorganic oxide film layer 115. The graphene oxide film layer 113 may have both excellent mechanical characteristics of the graphene layer 111 and oxide properties facilitating the chemical bond with the inorganic oxide film layer 115 through an oxygen functional group. Accordingly, as illustrated in FIG. 11A, it was confirmed that no crack or delamination had occurred to the inorganic oxide film layer 115 (e.g., a SiO₂ layer) bonded by the graphene oxide film layer 113. On the contrary, in a comparative example, it was confirmed that a crack or delamination had occurred to an inorganic oxide film layer (e.g., a SiO₂ layer) directly bonded to a graphene layer as illustrated in FIG. 11B.

As described above, as the graphene oxide film layer 113 bonds the graphene layer 111 and the inorganic oxide film layer 115, deadhesion or delamination of the graphene layer 111 and the inorganic oxide film layer 115 may be prevented. Thus, the graphene layer 111 may be prevented from being exposed to a high-temperature moist oxygen atmosphere, and the oxidation of the graphene layer 111 may be avoided.

Referring to FIG. 10D, a graphene oxide film layer 116 may be formed on the inorganic oxide film layer 115. A process of forming the graphene oxide film layer 116 on the inorganic oxide film layer 115 may be conducted by arranging the graphene layer 111 illustrated in FIGS. 10A and 10B and performing the oxidation process for oxidizing the graphene layer 111. In this regard, a thickness of the graphene oxide film layer 116 may be about 1 nm to about 5 nm, and an entire area of the graphene layer 111 may be oxidized to form the graphene oxide film layer 116.

However, the disclosure is not limited thereto, and the graphene oxide film layer 116 formed by the oxidation process performed outside may be transferred onto the inorganic oxide film layer 115.

Referring to FIG. 10E, the reduced graphene oxide film layer 117 may be formed by performing the oxidation process on the graphene oxide film layer 116 arranged on the inorganic oxide film layer 115. A reduction process may be performed on the graphene oxide film layer 116 by reducing the oxygen functional group formed at the graphene oxide film layer 116.

In an embodiment of the disclosure, when the thermal reduction process is performed, a predetermined high temperature of 200° C. or higher may be applied to the graphene oxide film layer 116 in a vacuum or a hydrogen gas for a predetermined process time (e.g., about 10 minutes to about 30 minutes).

The reduced graphene oxide film layer 117 formed through the reduction process performed on the graphene oxide film layer 116 may be arranged on the inorganic oxide film layer 115 and protect the graphene layer 111. The reduced graphene oxide film layer 117 according to an embodiment of the disclosure may have hydrophobicity by performing a reduction process on the graphene oxide film layer. As the reduced graphene oxide film layer 117 has hydrophobicity, the graphene layer 111 may be protected from moisture.

Although the thermal reduction process may be provided as a reduction process performed on the graphene oxide film layer 116 in this embodiment of the disclosure, the disclosure is not limited thereto, and the graphene oxide film layer 116 according to an embodiment of the disclosure may be reduced to the reduced graphene oxide film layer 117 through at least one of a chemical reduction process, an electrochemical reduction process, a plasma reduction process, or a photoreduction process.

Referring to FIG. 10F, the first electrode 150 and the second electrode 160 may be formed apart from each other with the graphene layer 111 interposed therebetween. The first electrode 150 and the second electrode 160 according to an embodiment of the disclosure may include a material having excellent electric conductivity. For example, the first electrode 150 and the second electrode 160 may include at least one from among Ag, Al, ITO, Cu, Mo, and Pt.

The first electrode 150 and the second electrode 160 according to an embodiment of the disclosure may be arranged to be in contact with the graphene layer 111 and may be arranged to over a partial area of the graphene layer 111 to avoid the exposure of the graphene layer 111 to the outside. Accordingly, the graphene layer 111 may stay hermetic to avoid contact with moisture or oxygen.

The first electrode 150 and the second electrode 160 according to an embodiment of the disclosure may be provided as a transparent electrode to secure the visibility such that the outside user may check the cooking process inside the cavity 20. In an embodiment of the disclosure, when the first electrode 150 and the second electrode 160 include Ag, the first electrode 150 and the second electrode 160 may be implemented as a thin line having a predetermined width W (e.g., about 5 nm to about 10 nm). As the first electrode 150 and the second electrode 160 are implemented as a thin line that may not be easily seen by the user, even when the first electrode 150 and the second electrode 160 are arranged, the visibility may be secured, and the outside user may see the cooking process inside the cavity 20.

According to an aspect of the disclosure, a planar-type heating apparatus configured to prevent degradation of heating characteristics by preventing oxidation of a graphene layer by moisture and oxygen may be provided.

According to an aspect of the disclosure, a planar-type heating apparatus may be provided and include a graphene oxide film layer between a graphene layer and an inorganic oxide film layer to improve adhesive force between the graphene layer and the inorganic oxide film layer.

According to an aspect of the disclosure, a planar-type heating apparatus may be provided in which a reduced graphene oxide film layer having hydrophobicity is arranged at the top of the planar-type heating apparatus to protect a graphene layer from moisture permeation.

According to an aspect of the disclosure, a planar-type heating apparatus with improved convenience in manufacturing may be provided.

According to an aspect of the disclosure, an electric oven may be provided with improved aesthetic characteristics and visibility, which enables a user to check a cooking process from the outside.

According to an aspect of the disclosure, an electric oven may be provided and include a cavity that is a space for cooking, a planar-type heating apparatus, an insulating portion, and a case have a transparent structure through which visible light is transmitted.

Aspects and effects of embodiments of the disclosure are not limited to the above, and other aspects and effects of embodiments of the disclosure that are not mentioned herein can be clearly understood from the description by a person skilled in the art.

A planar-type heating apparatus according to an embodiment of the disclosure may include a graphene layer having a predetermined thickness, a graphene oxide film layer arranged to surround the graphene layer, an inorganic oxide film layer arranged on the graphene oxide film layer, a first electrode arranged to be electrically connected to the graphene layer, and a second electrode electrically connected to the graphene layer and arranged apart from the first electrode with the graphene layer interposed therebetween.

The graphene layer may have a thickness of about 1 nm to about 5 nm.

A ratio between a thickness of the graphene layer and a thickness of the graphene oxide film layer 113 may be 3:1 to 5:1.

The graphene oxide film layer may have a thickness of about 0.3 nm to about 1 nm.

The inorganic oxide film layer may include at least one of SiO₂, TiO₂, Si₃N₄, or MoO₃.

The inorganic oxide film layer may have a thickness of about 10 nm to about 40 nm.

The planar-type heating apparatus may further include a reduced graphene oxide film layer arranged on the inorganic oxide film layer, wherein the reduced graphene oxide film layer may have a thickness of about 1 nm to about 5 nm.

The reduced graphene oxide film layer may have hydrophobicity.

The first electrode and the second electrode may each include at least one of Ag, Al, ITO, Cu, Mo, or Pt.

The first electrode and the second electrode may each have a width of about 5 nm to about 10 nm.

The first electrode and the second electrode may each include a transparent electrode.

The planar-type heating apparatus may further include a power unit connected to the first electrode and the second electrode.

An electric oven according to an embodiment of the disclosure includes a cavity including a top plate and a bottom plate that face each other, both side plates, and a rear plate, wherein a front of the cavity is open, a door selectively opening and closing the front of the cavity, and a planar-type heating apparatus arranged on a surface of at least one of the top plate, the bottom plate, the two side plates, or the rear plate to apply heat to the cavity.

At least one of the top plate, the bottom plate, the two side plates, or the rear plate may include a transparent substrate.

At least one of the top plate, the bottom plate, the two side plates, or the rear plate may include at least one of tempered glass, ceramics, or quartz glass.

The electric oven may further include a case arranged at a predetermined distance from the top plate, the bottom plate, the two side plates, and the rear plate.

The case may include a transparent substrate.

The electric oven may further include a bezel portion arranged on the case and in an area corresponding to the first electrode and the second electrode.

The case may include at least one of tempered glass, ceramics, or quartz glass.

The electric oven may further include an insulating portion arranged between the case and at least one of the top plate, the bottom plate, the two side plates, or the rear plate.

The insulating portion may include a transparent material.

The insulating portion may include at least one of tempered glass, ceramics, or quartz glass.

The planar-type heating apparatus according to an aspect of the disclosure may improve adhesive force between the graphene layer and the inorganic oxide film layer by the graphene oxide film layer being between the graphene layer and the inorganic oxide film layer.

The planar-type heating apparatus according to an aspect of the disclosure may prevent degradation of heating characteristics by preventing oxidation of the graphene layer by moisture and oxygen.

The planar-type heating apparatus according to an aspect of the disclosure may arrange the reduced graphene oxide film layer having hydrophobicity at the top of the planar-type heating apparatus to protect the graphene layer from moisture permeation.

The planar-type heating apparatus according to an aspect of the disclosure may improve the convenience in manufacturing.

The electric oven according to an aspect of the disclosure may include the cavity that is a space for cooking, the planar-type heating apparatus, the insulating portion, and the case that have a transparent structure through which visible light is transmitted.

The electric oven according to an aspect of the disclosure may include a transparent structure that enables a user to check the cooking process from the outside to improve aesthetic characteristics and visibility.

Although a planar-type heating apparatus and an electric oven including the same are described with reference to embodiments illustrated in the drawings, such embodiments are provided merely as an example, and it will be understood that various modifications and equivalents may be made from the embodiments by a person skilled in the art. Therefore, the various modifications and equivalents are included within the spirit and scope of the disclosure.

What is claimed is

1. A planar-type heating apparatus comprising:
a graphene layer;
a graphene oxide film layer on the graphene layer in a first direction;
an inorganic oxide film layer on the graphene oxide film layer in the first direction;
a first electrode electrically connected to the graphene layer; and
a second electrode electrically connected to the graphene layer,
wherein the graphene layer is between the first electrode and the second electrode.

2. The planar-type heating apparatus of claim 1, wherein a thickness of the graphene layer is in a range of 1 nm to 5 nm.

3. The planar-type heating apparatus of claim 1, wherein a ratio between a thickness of the graphene layer and a thickness of the graphene oxide film layer is 3:1 to 5:1.

4. The planar-type heating apparatus of claim 1, wherein a thickness of the graphene oxide film layer is in a range of 0.3 nm to 1 nm.

5. The planar-type heating apparatus of claim 1, wherein the inorganic oxide film layer comprises at least one of SiO₂, TiO₂, Si₃N₄, or MoO₃.

6. The planar-type heating apparatus of claim 1, wherein a thickness of the inorganic oxide film layer is in a range of 10 nm to 40 nm.

7. The planar-type heating apparatus of claim 1, further comprising a reduced graphene oxide film layer on the inorganic oxide film layer in the first direction,
wherein a thickness of the reduced graphene oxide film layer is in a range of 1 nm to 5 nm.

8. The planar-type heating apparatus of claim 7, wherein the reduced graphene oxide film layer has hydrophobicity.

9. The planar-type heating apparatus of claim 1, wherein the first electrode and the second electrode each comprise at least one of Ag, Al, indium tin oxide (ITO), Cu, Mo, or Pt.

10. The planar-type heating apparatus of claim 9, wherein a width of the first electrode and a width of the second electrode is in a range of 5 nm to 10 nm.

11. The planar-type heating apparatus of claim 1, wherein the first electrode and the second electrode each comprise a transparent electrode.

12. The planar-type heating apparatus of claim 1, further comprising a power supply connected to the first electrode and the second electrode.

13. An electric oven comprising:
a top plate;
a bottom plate facing the top plate;
a first side plate;
a second side plate facing the first side plate;
a rear plate;
a door configured to selectively open and close a front of a cavity, the cavity defined by the top plate, the bottom plate, the first side plate, the second side plate, and the rear plate; and
the planar-type heating apparatus according to claim 1, wherein the planar-type heating apparatus is configured to apply heat to the cavity, and the planar-type heating apparatus is on a surface of at least one of the top plate, the bottom plate, the first side plate, the second side plate, or the rear plate.

14. The electric oven of claim 13, wherein at least one of the top plate, the bottom plate, the first side plate, the second side plate, or the rear plate comprises a transparent substrate.

15. The electric oven of claim 14, wherein at least one from among the top plate, the bottom plate, the first side plate, the second side plate, and the rear plate comprises at least one of tempered glass, a ceramic, or quartz glass.

16. The electric oven of claim 14, further comprising a case that is spaced from the top plate, the bottom plate, the first side plate, the second side plate, and the rear plate.

17. The electric oven of claim 16,
wherein the case comprises a transparent substrate.

18. The electric oven of claim 17, further comprising a bezel portion on the case and overlapping with the first electrode and the second electrode.

19. The electric oven of claim 16, further comprising an insulating portion (50) between the case and at least one of the top plate, the bottom plate, the first side plate, the second side plate, or the rear plate.

20. The electric oven of claim 19,
wherein the insulating portion comprises a transparent material.
